(19) United States
(12) Patent Application Publication
(10) Pub. No.: US 2026/0229543 A1
(43) Pub. Date: Aug. 6, 2026

(54) ELECTRODE AND SECONDARY BATTERY INCLUDING ELECTRODE AND METHOD OF MANUFACTURING ELECTRODE

(71) Applicant: SAMSUNG SDI CO., LTD., Yongin-si (KR)

(72) Inventors: Eunhyeok SHIN, Yongin-si (KR); Taesu JEONG, Yongin-si (KR); Jungah YOON, Yongin-si (KR)

(21) Appl. No.: 19/276,201

(22) Filed: Jul. 22, 2025

(30) Foreign Application Priority Data
Feb. 3, 2025 (KR) 10-2025-0012881

(51) Int. Cl. H01M 4/66; H01M 4/04; H01M 10/052; H01M 50/109; H01M 50/474; H01M 50/486; H01M 50/536; H01M 50/586; H01M 50/595

(52) U.S. Cl. CPC H01M 4/667; H01M 4/0404; H01M 4/661; H01M 4/668; H01M 10/052; H01M 50/109; H01M 50/474; H01M 50/486; H01M 50/536; H01M 50/586; H01M 50/595

(57) ABSTRACT

An electrode may include a polymer layer including an insulating material, a metal layer formed on each of two surfaces of the polymer layer, an active material layer formed on a portion of the metal layer so that the metal layer may include a coated portion having the active material layer and a non-coated portion not having the active material layer, an electrode tab coupled to at least part of the non-coated portion, and an insulating layer formed on a portion of the electrode tab. A sum of a thicknesses of the electrode tab and a thickness of the insulating layer may be less than or equal to a thickness of the active material layer.

### CROSS-REFERENCE TO RELATED APPLICATION

The present application claims priority to and the benefit of Korean Application No. 10-2025-0012881, filed on Feb. 3, 2025, in the Korean Intellectual Property Office, the entire disclosure of which is incorporated by reference herein.

### BACKGROUND

### Field

The present disclosure relates to an electrode, a secondary battery including the electrode, and a method of manufacturing the electrode.

### Description of the Related Art

Unlike primary batteries that are not designed to be (re)charged, secondary (or rechargeable) batteries are designed to be discharged and recharged. Low-capacity secondary batteries are used in portable, small electronic devices, such as smart phones, feature phones, notebook computers, digital cameras, and camcorders, while large-capacity secondary batteries are widely used as power sources for driving motors in hybrid vehicles and electric vehicles and for storing power (e.g., home and/or utility scale power storage). A secondary battery generally includes an electrode assembly composed of a positive electrode and a negative electrode, a case housing the positive electrode and the negative electrode, and electrode terminals connected to the electrode assembly.

Various research and development efforts are underway to reduce the weight and cost of secondary batteries and to improve safety and increase energy density. Conventionally, because an electrode substrate formed of a metal is relatively heavy, composite substrates in which a thin metal layer is formed on both surfaces (i.e., the two major surfaces) of a lightweight insulating substrate, such as PET (polyethylene terephthalate), have recently been used. In order to electrically connect the metal layers formed on both surfaces of the insulating substrate, a separate metal substrate for serving as a tab may be joined to the metal layers. In this case, the bending length of the tab may increase, which may cause difficulties in making the secondary battery thinner.

The above information disclosed in this Background section is for enhancement of understanding of the background of the present disclosure, and therefore, it may contain information that does not constitute related (or prior) art.

### SUMMARY

The present disclosure provides an electrode, a secondary battery including the electrode, and a method of manufacturing the electrode to solve the above-described issues.

In some embodiments, an electrode may include a polymer layer including an insulating material, a metal layer formed on two sides of the polymer layer, an active material layer formed on a portion of the metal layer so that the metal layer may include a coated portion having the active material layer and a non-coated portion not having the active material layer, an electrode tab coupled to at least part of the non-coated portion, and an insulating layer formed on a portion of the electrode tab. A sum of a thicknesses of the electrode tab and a thickness of the insulating layer may be less than or equal to a thickness of the active material layer.

In some embodiments, the electrode tab may be joined to the non-coated portion by welding or by thermal fusion, and the electrode tab may include a joint formed by the welding or by the thermal fusion.

In some embodiments, the insulating layer may be formed on the joint of the electrode tab, a partial region of the electrode tab that may include the joint of the electrode tab, or the joint of the electrode tab and a portion of the active material layer.

In some embodiments, a width of the insulating layer may be about identical to a width of the joint or may be greater than the width of the joint.

In some embodiments, the insulating layer may include an insulating-solution-coating portion that may be coated by an insulating solution.

In some embodiments, the insulating solution may include at least one of polyimide (PI), ceramic, silicone, Ethylene Tetrafluoroethylene (ETFE), and Polychlorotrifluoroethylene (PCTFE).

In some embodiments, the insulating layer may include an insulating tape.

In some embodiments, the insulating tape may include at least one of acrylic, rubber, polyimide (PI), Ethylene Tetrafluoroethylene (ETFE), ceramic, silicone, polyester (PET), and Polychlorotrifluoroethylene (PCTFE).

In some embodiments, a secondary battery may include an electrode assembly including a first electrode, a separator, and a second electrode and a case housing the electrode assembly. At least one of the first electrode and the second electrode may include a polymer layer including an insulating material, a metal layer formed on two sides of the polymer layer, an active material layer formed on a portion of the metal layer so that the metal layer may include a coated portion having the active material layer and a non-coated portion not having the active material layer, an electrode tab coupled to at least part of the non-coated portion, and an insulating layer formed on a portion of the electrode tab. A sum of a thicknesses of the electrode tab and a thickness of the insulating layer may be less than or equal to a thickness of the active material layer.

In some embodiments, the electrode tab may be joined to the non-coated portion by welding or by thermal fusion, and the electrode tab may include a joint formed by the welding or by the thermal fusion.

In some embodiments, the insulating layer may be formed on the joint of the electrode tab, a partial region of the electrode tab that may include the joint of the electrode tab, or the joint of the electrode tab and a portion of the active material layer.

In some embodiments, a method of manufacturing an electrode may include forming a metal layer on two sides of a polymer layer including an insulating material, forming an active material layer on a portion of the metal layer so that the metal layer may include a coated portion having the active material layer and a non-coated portion not having the active material layer, thereby manufacturing an electrode plate, coupling an electrode tab including a metal to the non-coated portion, after coupling the electrode tab to the non-coated portion, forming an insulating layer on a portion of the electrode tab, and configuring a thickness of the electrode tab and a thickness of the insulating layer to be, together, less than or equal to a thickness of the active material layer.

In some embodiments, coupling the electrode tab may include welding or thermally fusing the electrode tab to the non-coated portion so that a joint may be formed in the electrode tab.

In some embodiments, forming the insulating layer includes, forming the insulating layer on the joint of the electrode tab, forming the insulating layer on a partial region of the electrode tab that may include the joint of the electrode tab, or forming the insulating layer on the joint of the electrode tab and a portion of the active material layer.

In some embodiments, the method further may include forming the insulating layer so that a width of the insulating layer may be about greater than or equal to a width of the joint.

In some embodiments, forming the insulating layer may include coating an insulating solution on a portion of the electrode tab.

In some embodiments, coating the insulating solution on a portion of the electrode tab may include spraying the insulating solution onto the portion of the electrode tab.

In some embodiments, coating the insulating solution on a portion of the electrode tab further may include drying the insulating solution after the insulating solution may be sprayed onto the portion of the electrode tab.

In some embodiments, forming the insulating layer may include attaching an insulating tape to a portion of the electrode tab.

In some embodiments, attaching the insulating tape to the portion of the electrode tab may include attaching, to a portion of the electrode tab, an insulating tape having at least one of acrylic, rubber, polyimide (PI), Ethylene Tetrafluoroethylene (ETFE), ceramic, silicone, polyester (PET), and Polychlorotrifluoroethylene (PCTFE).

According to some embodiments of the present disclosure, by satisfying a specified thickness conditions of the active material layer, the electrode tab, and the insulating layer, flatness and uniformity of the electrode may be achieved in a stacked or wound state of a plurality of electrodes. As a result, adhesion between the electrodes may be improved, and physical bonding strength may be enhanced. In addition, as the uniformity of the electrode may be achieved, the risk of short circuits may be reduced, and the accumulation of heat inside the secondary battery may be prevented.

According to some embodiments of the present disclosure, due to the above-mentioned thickness condition and a configuration in which the electrode tab is coupled to the non-coated portion of the electrode and an insulating layer is subsequently formed on the electrode tab, the bending length of the electrode may be reduced, thereby facilitating thinning the secondary battery. Moreover, the area that does not contribute to battery capacity may be minimized, thus improving energy density.

According to some embodiments of the present disclosure, an insulating layer formed by coating an insulating solution may be provided, enabling formation of an insulating layer of uniform thickness that conforms to various shapes of the electrode tab. As a result, a degree of freedom in designing the insulating layer may be increased, and the adhesion strength to the electrode tab may be enhanced, thus achieving durability and mechanical stability of the secondary battery.

However, aspects and features of the present disclosure are not limited to those described above, and other aspects and features not mentioned will be clearly understood by a person skilled in the art from the detailed description, described below.

### BRIEF DESCRIPTION OF DRAWINGS

The following drawings attached to this specification illustrate some embodiments of the present disclosure and show some aspects and features of the present disclosure together with the detailed description of the present disclosure. Thus, the present disclosure should not be construed as being limited to the embodiments shown in the drawings:

FIG. 1 is a cross-sectional view of an electrode according to some embodiments of the present disclosure.

FIG. 2 is a side view of an electrode according to some embodiments of the present disclosure.

FIG. 3 is a cross-sectional view of coupling positions of an electrode tab in an electrode according to some embodiments of the present disclosure.

FIG. 4 is a side view of coupling positions of an electrode tab in an electrode according to some embodiments of the present disclosure.

FIG. 5 is a cross-sectional view of an insulating layer when a coupling position of an electrode tab differs in an electrode according to some embodiments of the present disclosure.

FIG. 6 is a cross-sectional view of a secondary battery according to some embodiments of the present disclosure.

FIG. 7 is a cross-sectional view of an electrode assembly in the secondary battery of FIG. 6.

FIG. 8 is a flowchart of a method of manufacturing an electrode according to some embodiments of the present disclosure.

FIG. 9 is a diagram of a welding apparatus used in the method of manufacturing the electrode of FIG. 8.

FIG. 10 is a diagram of coupling an electrode tab to a non-coated portion in the method of manufacturing the electrode of FIG. 8.

FIG. 11 is a diagram of forming an insulating layer on a portion of an electrode tab in the method of manufacturing the electrode of FIG. 8.

### DETAILED DESCRIPTION

Hereinafter, embodiments of the present disclosure will be described, in detail, with reference to the accompanying drawings. The terms or words used in the present specification and claims are not to be limitedly interpreted as general or dictionary meanings and should be interpreted as meanings and concepts that are consistent with the technical idea of the present disclosure based on the principle that an inventor can be his/her own lexicographer to appropriately define concepts of terms to describe his/her invention in the best way.

The embodiments described in this specification and the configurations shown in the drawings are only some of the embodiments of the present disclosure and do not represent all of the technical spirit, aspects, and features of the present disclosure. Accordingly, it should be understood that there may be various equivalents and modifications that can replace or modify the embodiments described herein at the time of filing this application.

It will be understood that when an element or layer is referred to as being “on,” “connected to,” or “coupled to” another element or layer, it may be directly on, connected, or coupled to the other element or layer or one or more intervening elements or layers may also be present. When an element or layer is referred to as being “directly on,” “directly connected to,” or “directly coupled to” another element or layer, there are no intervening elements or layers present. For example, when a first element is described as being “coupled” or “connected” to a second element, the first element may be directly coupled or connected to the second element, or the first element may be indirectly coupled or connected to the second element via one or more intervening elements.

In the figures, dimensions of the various elements, layers, etc. may be exaggerated for clarity of illustration. The same reference numerals designate the same elements. As used herein, the term “and/or” includes any and all combinations of one or more of the associated listed items. Further, the use of “may” when describing embodiments of the present disclosure relates to “one or more embodiments of the present disclosure.” Expressions, such as “at least one of” and “any one of,” when preceding a list of elements, modify the entire list of elements and do not modify the individual elements of the list. When phrases such as “at least one of A, B, and C, “at least one of A, B, or C,” “at least one selected from a group of A, B, and C,” or “at least one selected from among A, B, and C” are used to designate a list of elements A, B, and C, the phrase may refer to any and all suitable combinations or a subset of A, B, and C, such as A, B, C, A and B, A and C, B and C, or A and B and C. As used herein, the terms “use,” “using,” and “used” may be considered synonymous with the terms “utilize,” “utilizing,” and “utilized,” respectively. As used herein, the terms “substantially,” “about,” and similar terms are used as terms of approximation and not as terms of degree, and are intended to account for the inherent variations in measured or calculated values that would be recognized by those of ordinary skill in the art.

It will be understood that, although the terms first, second, third, etc. may be used herein to describe various elements, components, regions, layers, and/or sections, these elements, components, regions, layers, and/or sections should not be limited by these terms. These terms are used to distinguish one element, component, region, layer, or section from another element, component, region, layer, or section. Thus, a first element, component, region, layer, or section discussed below could be termed a second element, component, region, layer, or section without departing from the teachings of exemplary embodiments.

Spatially relative terms, such as “beneath,” “below,” “lower,” “above,” “upper,” and the like, may be used herein for ease of description to describe one element or feature's relationship to another element(s) or feature(s) as illustrated in the figures. It will be understood that the spatially relative terms are intended to encompass different orientations of the device in use or operation in addition to the orientation depicted in the figures. For example, if the device in the figures is turned over, elements described as “below” or “beneath” other elements or features would then be oriented “above” or “over” the other elements or features. Thus, the term “below” may encompass both an orientation of above and below. The device may be otherwise oriented (rotated 90 degrees or at other orientations), and the spatially relative descriptors used herein should be interpreted accordingly.

The terminology used herein is for the purpose of describing embodiments of the present disclosure and is not intended to be limiting of the present disclosure. As used herein, the singular forms “a” and “an” are intended to include the plural forms as well, unless the context clearly indicates otherwise. It will be further understood that the terms “includes,” “including,” “comprises,” and/or “comprising,” when used in this specification, specify the presence of stated features, integers, steps, operations, elements, and/or components but do not preclude the presence or addition of one or more other features, integers, steps, operations, elements, components, and/or groups thereof.

Also, any numerical range disclosed and/or recited herein is intended to include all sub-ranges of the same numerical precision subsumed within the recited range. For example, a range of “1.0 to 10.0” is intended to include all subranges between (and including) the recited minimum value of 1.0 and the recited maximum value of 10.0, that is, having a minimum value greater than or equal to 1.0 and a maximum value less than or equal to 10.0, such as, for example, 2.4 to 7.6. Any maximum numerical limitation recited herein is intended to include all lower numerical limitations subsumed therein, and any minimum numerical limitation recited in this specification is intended to include all higher numerical limitations subsumed therein. Accordingly, Applicant reserves the right to amend this specification, including the claims, to expressly recite any sub-range subsumed within the ranges expressly recited herein. All such ranges are intended to be inherently described in this specification such that amending to expressly recite any such subranges would comply with the requirements of 35 U.S.C. § 112(a) and 35 U.S.C. § 132(a).

References to two compared elements, features, etc. as being “the same” may mean that they are “substantially the same.” Thus, the phrase “substantially the same” may include a case having a deviation that is considered low in the art, for example, a deviation of 5% or less. In addition, when a certain parameter is referred to as being uniform in a given region, it may mean that it is uniform in terms of an average.

Throughout the specification, unless otherwise stated, each element may be singular or plural.

Arranging an arbitrary element “above (or below)” or “on (or under)” another element may mean that the arbitrary element may be disposed in contact with the upper (or lower) surface of the element, and another element may also be interposed between the element and the arbitrary element disposed on (or under) the element.

In addition, it will be understood that when a component is referred to as being “linked,” “coupled,” or “connected” to another component, the elements may be directly “coupled,” “linked” or “connected” to each other, or another component may be “interposed” between the components.

Throughout the specification, when “A and/or B” is stated, it means A, B or A and B, unless otherwise stated. That is, “and/or” includes any or all combinations of a plurality of items enumerated. When “C to D” is stated, it means C or more and D or less, unless otherwise specified.

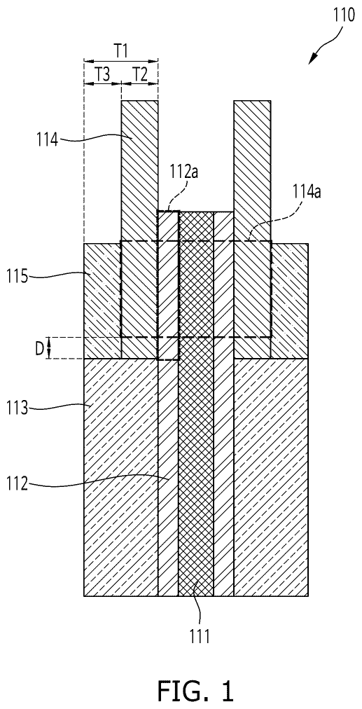

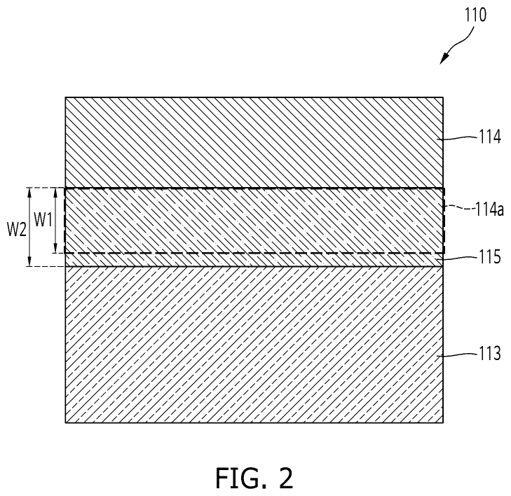

FIG. 1 is a cross-sectional view of a first electrode 110 according to some embodiments of the present disclosure. FIG. 2 is a side view of the first electrode 110 according to some embodiments of the present disclosure.

In some embodiments, the first electrode 110 may include a polymer layer 111 formed of an insulating material, a metal layer(s) 112 formed on both surfaces of the polymer layer 111, an active material layer(s) 113 formed on a portion of the metal layer(s) 112 such that a non-coated portion(s) 112a is formed in the metal layer(s) 112, an electrode tab(s) 114 coupled to at least part of the non-coated portion(s) 112a, and an insulating layer(s) 115 formed on a portion of the electrode tab(s) 114. The polymer layer 111 and the metal layers 112 formed on both surfaces of the polymer layer 111 may form a current collector. Further, the electrode tab 114 may be a substrate tab, a lead tab, or the like.

The polymer layer 111 may include a polymer material of an insulating property. For example, the polymer layer 111 may be made of a polyethylene terephthalate (PET) resin. However, the material of the polymer layer 111 is not limited thereto. For example, the polymer layer 111 may be made of a polyester resin such as polytrimethylene terephthalate (PTT), polybutylene terephthalate (PBT), or polyethylene naphthalate (PEN).

The metal layers 112 may be formed on the polymer layer 111 using a metal material such as copper, a copper alloy, nickel, or a nickel alloy, or may be formed of a metal material such as aluminum or an aluminum alloy. The metal layers 112 formed on both surfaces of the polymer layer 111 may be formed of the same metal material or of different metal materials. The metal layers 112 may be formed of a combination of two or more metal layers. The metal layers 112 may function as a positive electrode or a negative electrode.

The active material layers 113 may be formed on a portion of the metal layers 112 so that the non-coated portion 112a is formed in the metal layers 112. The non-coated portion 112a corresponds to an area of the metal layers 112 where the active material layer 113 is not formed, and the electrode tab 114 may be coupled to the non-coated portion 112a.

When the metal layers 112 are formed of a metal material such as copper, a copper alloy, nickel, or a nickel alloy, the active material layers 113 may be configured to include a negative active material, together with a binder and a conductive material, and the negative active material may include, for example, graphite.

When the metal layers 112 are formed of a metal material such as aluminum or an aluminum alloy, the active material layers 113 may be configured to include a positive active material, together with a binder and a conductive material, and the positive active material may include, for example, a transition metal oxide.

In some embodiments, the electrode tab 114 may be made of a metal material and may be joined to the non-coated portion 112a of the metal layers 112 so as to be electrically connected to the metal layers 112. The electrode tab 114 may be made of the same material as the metal layers 112. For example, when the metal layers 112 are formed of copper, a copper alloy, nickel, or a nickel alloy, the electrode tab 114 may be made of copper, a copper alloy, nickel, or a nickel alloy. When the metal layers 112 are formed of aluminum or an aluminum alloy, the electrode tab 114 may be made of aluminum or an aluminum alloy.

In some embodiments, the electrode tab 114 may be made of a different material than the metal layers 112. The electrode tab 114 may be formed of any material having excellent electrical conductivity. In some embodiments, the metal layers 112 may include aluminum or an aluminum alloy, while the electrode tab 114 may include copper or a copper alloy.

The electrode tab 114 may be joined to the non-coated portion 112a of the metal layers 112 by methods such as welding or thermal fusion. For example, the electrode tab 114 may be joined to the non-coated portion 112a of the metal layers 112 by ultrasonic welding. After placing the electrode tab 114 on each of a pair of the metal layers 112, the pair of electrode tabs 114 may be ultrasonically welded simultaneously, so that the electrode tab 114 is joined to each of the pair of the metal layers 112. When the electrode tab 114 is ultrasonically welded to the non-coated portion 112a, a joint 114a may be formed in the electrode tab 114 by ultrasonic welding. Therefore, the electrode tab 114 may include the joint 114a formed by welding. However, the method by which the electrode tab 114 is joined to the non-coated portion 112a of the metal layers 112 is not limited thereto. In another example, the electrode tab 114 may be joined to the non-coated portion 112a of the metal layers 112 by laser welding, resistance welding, tungsten inert gas (TIG) welding, heat fusion, or the like.

In some embodiments, the width W1 of the joint 114a may be greater than or equal to about 1 mm, preferably greater than or equal to about 1.5 mm, to achieve stable welding. The width W1 of the joint 114a refers to the size in the direction perpendicular to the boundary line between the non-coated portion 112a and the active material layer 113. In some embodiments, the joint 114a may be set to have a minimum width sufficient to secure the welding strength. For example, the width W1 of the joint 114a may be about 1.5 mm. However, the width W1 of the joint 114 a is not limited thereto. The width W1 of the joint 114a may vary depending on the type and thickness of the polymer layer 111, the metal layers 112, and the electrode tab 114.

The insulating layer 115 may be formed on a portion of the electrode tab 114 after coupling the electrode tab 114 to the non-coated portion 112a of the metal layers 112. The insulating layer 115 may be made of an insulating material such as a polymer (e.g., a high molecular compound), a resin, or rubber that does not conduct electricity. In some embodiments, the insulating layer 115 may be formed on the joint 114a of the electrode tab 114. Additionally, the insulating layer 115 may be formed on a partial region of the electrode tab 114 that includes the joint 114a. Additionally, the insulating layer 115 may be formed on the joint 114a of the electrode tab 114 and on a portion of the active material layer 113.

In some embodiments, the insulating layer 115 may be formed by coating an insulating material on a portion of the electrode tab 114. Thus, the insulating layer 115 may include a coating portion of an insulating solution coated on a portion of the electrode tab 114. The insulating solution may include at least one of polyimide (PI), Ethylene Tetrafluoroethylene (ETFE), ceramic, silicone, polyester (PET), and Polychlorotrifluoroethylene (PCTFE).

By providing the insulating layer 115 utilizing such insulating solution coating, a uniform-thickness insulating layer may be secured in accordance with various shapes of the electrode tab 114, thereby increasing the degree of freedom in designing the insulating layer, and because adhesion strength with the electrode tab 114 is high, durability and mechanical stability of the secondary battery may be improved.

In some embodiments, the insulating layer 115 may be formed by attaching an insulating film in the form of a film to a portion of the electrode tab 114. For example, the insulating layer 115 may include an insulating tape attached to a portion of the electrode tab 114. Further, the insulating tape may be attached so as to fully cover the joint 114a of the electrode tab 114. Further, the insulating tape may be formed of a material that includes at least one of acrylic, rubber, polyimide (PI), Ethylene Tetrafluoroethylene (ETFE), ceramic, silicone, polyester (PET), and Polychlorotrifluoroethylene (PCTFE). The insulating tape may be attached to a portion of the electrode tab 114 using, for example, a UV-curable adhesive. However, the method of attaching the insulating tape to the electrode tab 114 is not limited thereto, and heat bonding, pressing, or similar methods may be utilized. In some embodiments, the length of the insulating tape may be less than or equal to n the length of the electrode assembly. More specifically, the length of the insulating tape in a certain direction may be less than or equal to the length of the polymer layer, the metal layer, and/or the active material layer in a certain direction, such as, for example, a direction parallel to the boundary line between the non-coated portion 112a and the active material layer 113.

By providing the insulating layer 115 utilizing the insulating tape, uniformity in insulation thickness may be improved. Because the insulating layer 115 is formed simply by attaching the insulating tape, an additional drying process or the like may be omitted, creating convenience in the process. Also, because the insulating tape allows easy maintenance after assembly, if the insulating layer is damaged or the customer's requirements change, quick and efficient responses are possible by a simple tape replacement.

When welding the electrode tab 114 to the non-coated portion 112a, welding may be performed at a location spaced apart by a predetermined distance D from the active material layer 113 so as to prevent the active material layer 113 from being damaged or deformed. The joint 114a may be formed at a location spaced apart by the predetermined distance D from the active material layer 113. For example, the joint 114 a may be formed at a location spaced apart by about 0 mm to about 0.25 mm from the active material layer 113. Furthermore, if welding is performed at a location spaced apart by greater than about 0.25 mm from the active material layer 113, an area that does not contribute to battery capacity may increase, which is disadvantageous in terms of battery capacity. However, the distance D by which the joint 114a is spaced from the active material layer 113 is not limited thereto and may vary depending on the type(s) of material(s) and thicknesses of the active material layer 113 and the electrode tab 114.

The insulating layer 115 may be formed on a portion of the electrode tab 114. In some embodiments, the insulating layer 115 may cover a portion of the active material layer 113. The insulating layer 115 may be formed on the electrode tab 114 to prevent the electrode tab 114 from causing a short circuit with an electrode of the opposite polarity in a stacked or wound state of the first electrode 110 with other electrodes of opposite polarity. In some embodiments, the insulating layer 115 may be formed on the joint 114a of the electrode tab 114. The width W2 of the insulating layer 115 may be identical or about identical to or greater than the width W1 of the joint 114a.

In some embodiments, as shown in FIGS. 1 and 2, when the electrode tab 114 is formed in contact with or adjacent to the active material layer 113, and the joint 114a is formed in the electrode tab 114, the electrode tab 114 may be located between the joint 114a and the active material layer 113. In this case, the width W2 of the insulating layer 115 may be formed larger than the width W1 of the joint 114a. If the width W2 of the insulating layer 115 is formed identically or about identically to the width W1 of the joint 114a, and the insulating layer 115 is formed on the joint 114a, a portion of the electrode tab 114 may be exposed to the outside through a gap between the insulating layer 115 and the active material layer 113. Therefore, the width W2 of the insulating layer 115 may be formed larger than the width W1 of the joint 114a, so as to cover the electrode tab 114 located between the joint 114a and the active material layer 113 so that the electrode tab 114 is not exposed to the outside. However, the width W2 of the insulating layer 115 is not limited thereto. In some embodiments, the width W2 of the insulating layer 115 may also be formed smaller than the width W1 of the joint 114a. The insulating layer 115 may be arranged so that the portion of the electrode tab 114 positioned between the joint 114a and the active material layer 113 is not exposed to the outside.

Referring to FIG. 1, the sum of the thickness T2 of the electrode tab 114 and the thickness T3 of the insulating layer 115 may be less than or equal to the thickness T1 of the active material layer 113. The thickness T1 of the active material layer 113 may refer to the thickest portion in the cross section of the active material layer. In some embodiments, the insulating solution may be coated on the electrode tab 114 in consideration of the thickness T2 of the electrode tab 114 so as not to exceed the thickness T1 of the active material layer 113 formed on a portion of the metal layers 112. In some embodiments, after the insulating solution is coated on the electrode tab 114 so as to exceed the thickness T1 of the active material layer 113 formed on a portion of the metal layers 112, a pressing process may be performed so that, in the final state, the sum of the thickness T3 of the insulating layer 115 and the thickness T2 of the electrode tab 114 is less than or equal to the thickness T1 of the active material layer 113. In some embodiments, the insulating tape may be attached to the electrode tab 114 in consideration of the thickness T2 of the electrode tab 114 so as not to exceed the thickness T1 of the active material layer 113 formed on a portion of the metal layers 112. The thickness T3 of the insulating layer that includes the insulating tape may be less than or equal to 30 micrometers. However, the thickness T3 of the insulating layer 115 is not limited thereto, and may vary depending on the configuration, specifications, and arrangement of the active material layer 113 and the electrode tab 114.

Due to the thickness condition for the active material layer 113, the electrode tab 114, and the insulating layer 115, flatness and uniformity of the electrode may be achieved when a plurality of electrodes are stacked or wound, adhesion between the plurality of electrodes may be improved, and physical bonding force may be enhanced. Also, because the uniformity of the electrode is ensured, the risk of a short circuit is reduced, and heat accumulation inside the secondary battery may be prevented.

By providing the above-mentioned thickness condition and a configuration in which the insulating layer 115 is formed on the electrode tab 114 after coupling the electrode tab 114 to the non-coated portion 112a of the first electrode 110, a bending length of the electrode may be reduced, facilitating making the secondary battery thinner, and an area that does not contribute to battery capacity may be minimized, thereby improving energy density.

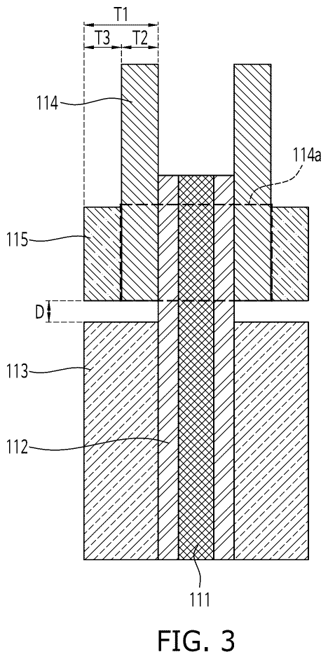

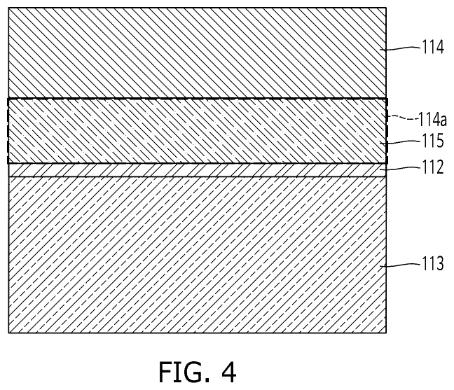

FIG. 3 is a cross-sectional view of coupling positions of an electrode tab in the electrode according to some embodiments of the present disclosure. FIG. 4 is a side view of coupling positions of an electrode tab in an electrode according to some embodiments of the present disclosure. Hereinafter, redundant descriptions overlapping with those in FIGS. 1 and 2 may be omitted for FIGS. 3 and 4.

The electrode tab 114 may be arranged to be spaced apart by a predetermined distance D from the active material layer 113. The joint 114a may be spaced apart by the distance D from the active material layer 113, and the electrode tab 114 may also be spaced apart from the active material layer 113 by the same distance D. The joint 114a may be formed at an end of the electrode tab 114. That is, the distance D between the active material layer 113 and the joint 114a may be equal to the distance D between the active material layer 113 and the end of the electrode tab 114. In some embodiments, the electrode tab 114 may be spaced apart by about 0 mm to about 0.25 mm from the active material layer 113.

The insulating layer 115 may also be arranged to be spaced apart from the active material layer 113 similarly to the electrode tab 114. The joint 114a may be formed at an end of the electrode tab 114, and the insulating layer 115 may be formed on the joint 114a. In some embodiments, the insulating layer 115 may be formed to be spaced apart by about 0 mm to about 0.25 mm from the active material layer 113. Also, a width of the insulating layer 115 may be identical to or similar to a width of the joint 114a so as to cover the joint 114a. However, the width of the insulating layer 115 is not limited thereto. For example, as long as the electrode tab 114 can be insulated from an electrode of the opposite polarity, the width of the insulating layer 115 may be formed smaller than the width W1 of the joint 114a. In some embodiments, the insulating layer 115 may be arranged so that the electrode tab 114 is not exposed between the insulating layer 115 and the active material layer 113. In other embodiments, the insulating layer 115 may be in contact with the active material layer 113 rather than being spaced apart therefrom. In this case, the metal layers 112 may be covered by the insulating layer 115. In other embodiments, the insulating layer 115 may be arranged to partially overlap the active material layer 113.

Referring to FIG. 3, the sum of the thickness T3 of the insulating layer 115 and the thickness T2 of the electrode tab 114 may be less than or equal to the thickness T1 of the active material layer 113. The thickness T1 of the active material layer 113 may refer to the thickest portion in the cross section of the active material layer. The insulating solution may be coated on the electrode tab 114 in consideration of the thickness T2 of the electrode tab 114 so as not to exceed the thickness T1 of the active material layer 113 formed on a portion of the metal layers 112. In some embodiments, after the insulating solution is coated on the electrode tab 114 so as to exceed the thickness T1 of the active material layer 113 formed on a portion of the metal layers 112, a pressing process may be performed so that, in the final state, the sum of the thickness T3 of the insulating layer 115 and the thickness T2 of the electrode tab 114 is less than or equal to the thickness T1 of the active material layer 113. In some embodiments, the insulating tape may be attached to the electrode tab 114 in consideration of the thickness T2 of the electrode tab 114 so as not to exceed the thickness T1 of the active material layer 113 formed on a portion of the metal layers 112. In some embodiments, the thickness T3 of the insulating layer including the insulating tape may be less than or equal to 30 micrometers. However, the thickness T3 of the insulating layer 115 is not limited thereto, and may vary depending on the configuration, specifications, and arrangement of the active material layer 113 and the electrode tab 114.

When the electrode tab 114 is arranged to be spaced apart from the active material layer 113 by a predetermined distance, the insulating layer 115 may be extended over the joint 114a and formed on the non-coated portion 112a exposed between the electrode tab 114 and the active material layer 113.

When the electrode tab 114 is arranged to be spaced apart from the active material layer 113 by a predetermined distance, a portion of the non-coated portion 112a may be exposed to the outside through the gap between the electrode tab 114 and the active material layer 113. Thus, the insulating layer 115 may be arranged to cover the joint 114a and may also cover the metal layers 112 exposed between the electrode tab 114 and the active material layer 113. In some embodiments, the insulating layer 115 may be arranged to cover the metal layers 112 exposed between the electrode tab 114 and the active material layer 113 as well as a portion of the active material layer 113, while covering the joint 114a.

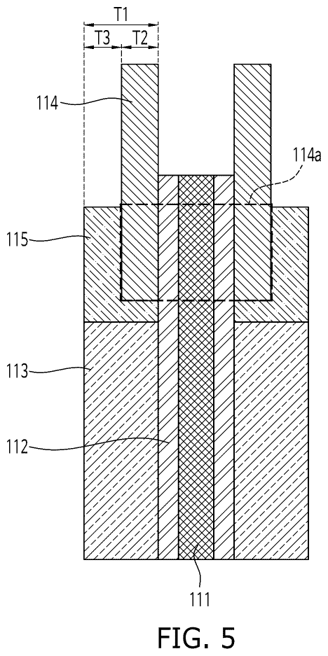

FIG. 5 is a cross-sectional view of an insulating layer when a coupling position of an electrode tab differs in an electrode according to some embodiments of the present disclosure. Hereinafter, redundant descriptions overlapping with those in FIGS. 1 through 4 may be omitted for FIG. 5.

The sum of the thickness T3 of the insulating layer 115 and the thickness T2 of the electrode tab 114 may be less than or equal to the thickness T1 of the active material layer 113. The thickness T1 of the active material layer 113 may refer to the thickest portion in the cross section of the active material layer. In some embodiments, the insulating solution may be coated on the electrode tab 114 in consideration of the thickness T2 of the electrode tab 114 so as not to exceed the thickness T1 of the active material layer 113 formed on a portion of the metal layers 112. In some embodiments, after the insulating solution is coated on the electrode tab 114 so as to exceed the thickness T1 of the active material layer 113 formed on a portion of the metal layers 112, a pressing process may be performed so that, in the final state, the sum of the thickness T3 of the insulating layer 115 and the thickness T2 of the electrode tab 114 is less than or equal to the thickness T1 of the active material layer 113. In some embodiments, the insulating tape may be attached to the electrode tab 114 in consideration of the thickness T2 of the electrode tab 114 so as not to exceed the thickness T1 of the active material layer 113 formed on a portion of the metal layers 112. In some embodiments, the thickness T3 of the insulating layer including the insulating tape and attached to the electrode tab 114 may be less than or equal to 30 micrometers. However, the thickness T3 of the insulating layer 115 formed on the electrode tab 114 is not limited thereto, and may vary depending on the configuration, specifications, and arrangement of the active material layer 113 and the electrode tab 114.

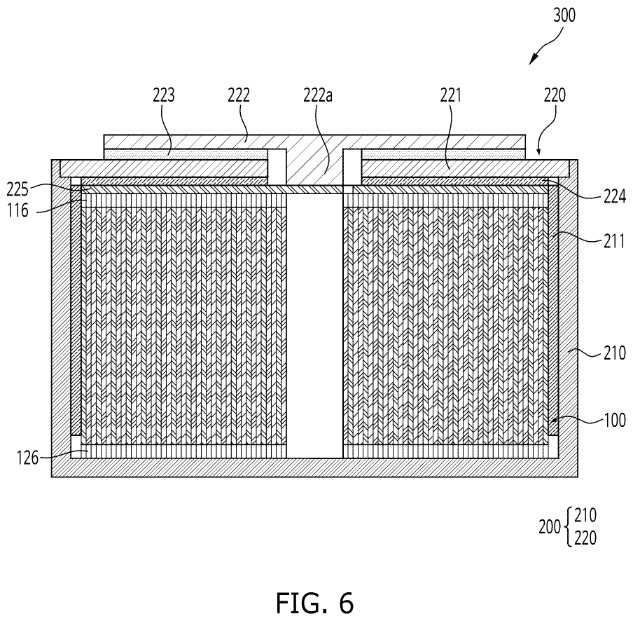

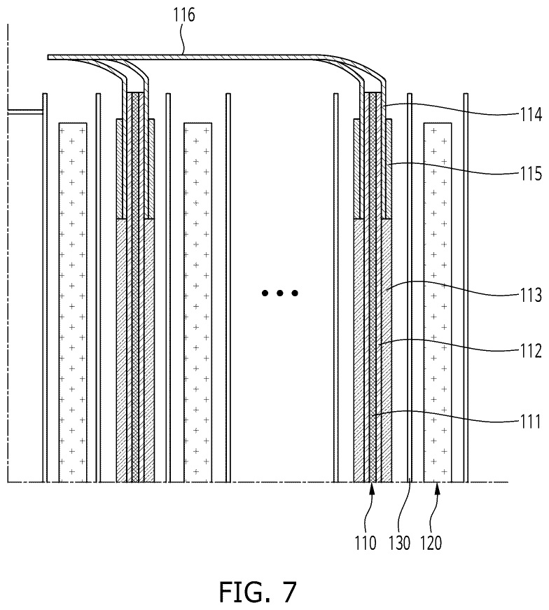

FIG. 6 is a cross-sectional view of a secondary battery 300 according to some embodiments of the present disclosure. FIG. 7 is a cross-sectional view of an electrode assembly in the secondary battery 300 of FIG. 6. Hereinafter, redundant descriptions overlapping with those in FIGS. 1 through 5 may be omitted for FIGS. 6 and 7.

In some embodiments, the secondary battery 300 may include an electrode assembly 100 including a first electrode 110, a second electrode 120, and a separator 130, and the secondary battery 300 may also include a case 200 housing the electrode assembly 100.

The case 200 may be formed with a hollow interior to house the electrode assembly 100 therein. The case 200 may include a case body 210 having a hollow interior and an opening formed in one surface, and a cap assembly 220 coupled to an opening of the case body 210 to seal the case body 210. The case 200 may be formed of a conductive metal such as aluminum, an aluminum alloy, or nickel-plated steel. In some embodiments, the case 200 may be formed of stainless steel (steel use stainless, SUS).

The case 200 may further include an insulator 211 disposed on an inner circumferential surface of the case body 210 to electrically insulate the case body 210 from the electrode assembly 100. A current collector 225 provided inside the case body 210 and a first electrode tab 116 may act as an opposite electrode relative to the case body 210. Thus, by providing the insulator 211 on the inner circumferential surface of the case body 210, the current collector 225 and the first electrode tab 116 may be electrically insulated from the case body 210.

The cap assembly 220 may include a cap plate 221 having a through-hole, a terminal plate 222 disposed on the cap plate 221 and having a protrusion 222a inserted into the through-hole of the cap plate 221, an outer insulator 223 disposed between the cap plate 221 and the terminal plate 222, and an inner insulator 224 disposed on an inner circumferential surface of the cap plate 221 to insulate the current collector 225 from the cap plate 221. The current collector 225 may be bonded to the protrusion 222a at its center, and the inner surface of the current collector 225 may contact the first electrode tab 116 of the first electrode 110 so as to electrically connect the first electrode 110 and the terminal plate 222.

The cap plate 221 may be formed in a disk shape with a through-hole at its center. As shown in FIG. 6, the cap plate 221 may be formed to have a larger diameter than the terminal plate 222 and the outer insulator 223. The cap plate 221 may be inserted into a fastening groove formed at the upper end of the case body 210, which is recessed to seal the opening of the case body 210. The shape of the cap plate 221 is not limited to this, and the cap plate 221 may be formed in various shapes corresponding to the shape of the case body 210 to which it is fastened.

The terminal plate 222 may be formed in a disk shape having a smaller diameter than that of the cap plate 221, and a protrusion 222a may be formed at its center so as to be inserted through the through-hole of the cap plate 221. In a state where the protrusion 222a is inserted into the through-hole of the cap plate 221, the protrusion 222a may protrude toward the inside of the case body 210. The protrusion 222a is a structure to which the current collector 225 is attached. The shape of the terminal plate 222 is not limited to a disk and may be implemented in various shapes corresponding to the shape of the cap plate 221.

The outer insulator 223 may be disposed between the cap plate 221 and the terminal plate 222 to electrically insulate the cap plate 221 from the terminal plate 222. Further, the outer insulator 223 may be made of a resin such as polypropylene (PP) or polyethylene (PE).

The outer insulator 223 may be formed in a disk shape similar to the cap plate 221, with an insertion hole at its center. Through the insertion hole of the outer insulator 223 and the through-hole of the cap plate 221, the protrusion 222a of the terminal plate 222 may pass such that the current collector 225 is attached to the protrusion 222a.

The inner insulator 224 may be disposed between the cap plate 221 and the current collector 225 to electrically insulate the cap plate 221 from the current collector 225. Because the cap plate 221 and the current collector 225 are formed of conductive metal, and the cap plate 221 is electrically connected to the second electrode tab 126, while the current collector 225 is electrically connected to the first electrode tab 116, the inner insulator 224 may insulate the cap plate 221 from the current collector 225 to prevent a short circuit. Further, the inner insulator 224 may be made of a resin such as polypropylene (PP) or polyethylene (PE).

The inner insulator 224 may also be formed in a disk shape similar to the cap plate 221, with an insertion hole at its center. Through the insertion hole of the inner insulator 224 and the through-hole of the cap plate 221, the protrusion 222a of the terminal plate 222 may pass so that the current collector 225 is coupled to the protrusion 222a. The outer diameter of the inner insulator 224 may be formed smaller than the outer diameter of the cap plate 221. Because an end of the cap plate 221 is coupled to the case body 210, the inner insulator 224 may be formed to have a smaller outer diameter than that of the cap plate 221.

The electrode assembly 100 may include a separator 130, a first electrode 110 disposed on one side of the separator 130, and a second electrode 120 disposed on the other side of the separator 130, which may be wound in a jelly-roll shape. The electrode assembly 100 is not limited thereto and may also be in a form in which a plurality of first electrodes, separators, and second electrodes are sequentially stacked.

The first electrode 110 may include a first substrate and a first active material layer on the first substrate. A first non-coated portion, in which the first active material layer is not positioned, may have a first electrode tab 116 formed thereon. The first electrode tab 116 may protrude to one side of the separator 130 and come into close contact with the current collector 225, thereby electrically connecting the first electrode tab 116 with the terminal plate 222.

The second electrode 120 may include a second substrate and a second active material layer on the second substrate. A second non-coated portion, in which the second active material layer is not positioned, may have a second electrode tab 126 formed thereon. In a state where the electrode assembly 100 is wound in a jelly-roll shape, the second electrode tab 126 may protrude toward the other side of the separator 130, contact the case body 210, and electrically connect the second electrode 120 and the case body 210.

In some embodiments, the first electrode tab 116 and the second electrode tab 126 may be formed as a plurality of tabs through a notching and/or stamping process. In this case, after bending the plurality of tabs to overlap them, the overlapped plurality of tabs may be pressed using a compression jig.

The first electrode 110 may function as a positive electrode. In some embodiments, the first substrate may be, for example, an aluminum foil, and the first active material layer may include, for example, a transition metal oxide. The second electrode 120 may function as a negative electrode. In some embodiments, the second substrate may be, for example, a copper foil or a nickel foil, and the second active material layer may include, for example, graphite. The reverse is also possible.

The separator 130 prevents a short circuit between the first electrode 110 and the second electrode 120 while allowing movement of lithium ions therebetween. The separator 130 may be made of, for example, a polyethylene film, a polypropylene film, or a polyethylene-polypropylene film.

The secondary battery described with reference to FIG. 6 may be a coin-type or button-type battery. The shape of the secondary battery is not limited thereto and may also be applied to other types of secondary batteries, such as a cylindrical battery, a prismatic battery, a pouch-type battery, or an SUS can battery. Also, although FIG. 6 illustrates a form in which the first electrode tab 116 is protruded upward and connected to the cap assembly 220 and the second electrode tab 126 is protruded downward and connected to the case body 210, the present disclosure is not limited thereto. Both the first electrode tab 116 and the second electrode tab 126 may protrude upward and be respectively connected to the cap assembly 220 and the case body 210 in other configurations.

Referring to FIG. 7, the first electrode 110 may include a polymer layer 111 made of an insulating material, metal layers 112 formed on both surfaces of the polymer layer 111, active material layers 113 formed on a portion of the metal layers 112 such that a non-coated portion is formed in the metal layers 112, an electrode tab 114 coupled to at least part of the non-coated portion, and an insulating layer 115 formed on a portion of the electrode tab 114. The first electrode 110 may be identical or about identical to the first electrode 110 described with reference to FIGS. 1 through 5, and a detailed description thereof is thus omitted. The second electrode 120 may also be configured in the same manner as the first electrode 110.

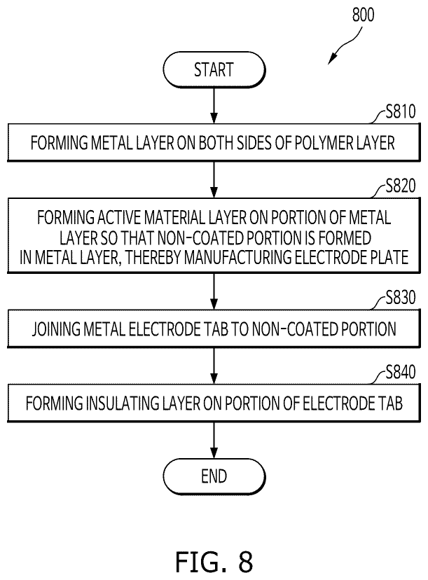

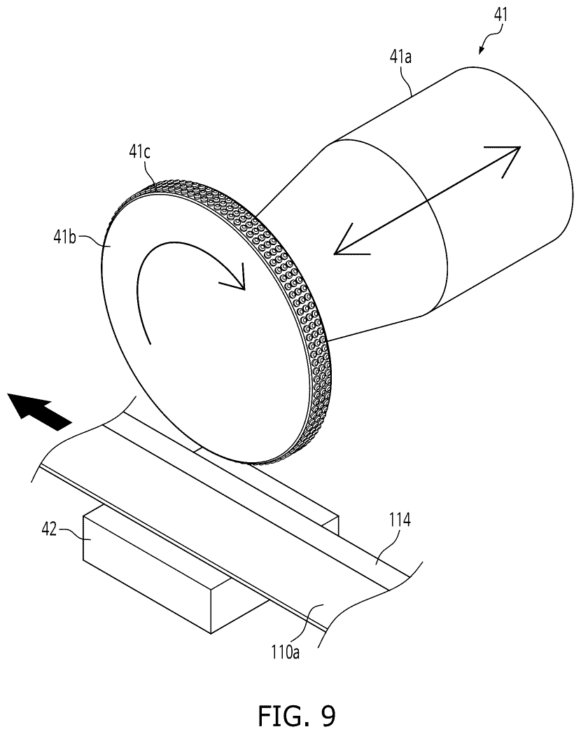

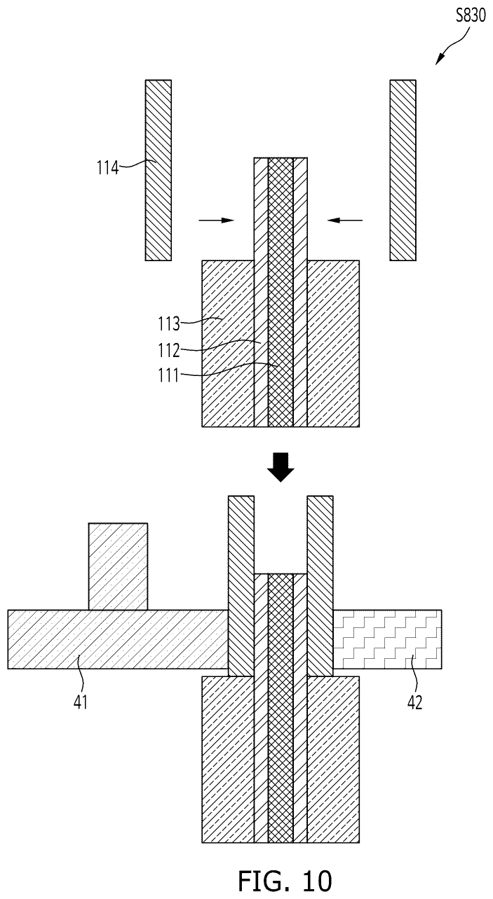

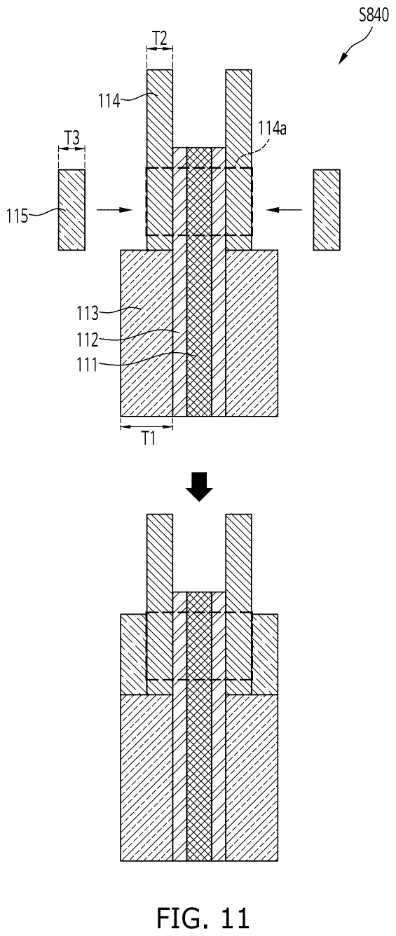

FIG. 8 is a flowchart illustrating a method 800 of manufacturing an electrode according to some embodiments of the present disclosure. FIG. 9 is a diagram of a welding apparatus used in the method 800 of manufacturing the electrode of FIG. 8. FIG. 10 is a diagram of coupling an electrode tab to a non-coated portion in the method 800 of manufacturing the electrode of FIG. 8. FIG. 11 is a diagram of forming an insulating layer on a portion of the electrode tab in the method 800 of manufacturing an electrode of FIG. 8. Hereinafter, redundant descriptions overlapping with those in FIGS. 1 through 7 may be omitted for FIGS. 8 through 11.

In some embodiments, the method 800 for manufacturing the electrode may include a step S810 of forming metal layers 112 on both surfaces of a polymer layer 111 formed of an insulating material; a step S820 of forming an active material layer 113 on a portion of the metal layers 112 so that a non-coated portion 112a is formed in the metal layers 112, thereby manufacturing an electrode plate 110a; a step S830 of coupling an electrode tab 114 formed of a metal to the non-coated portion 112a; and, after coupling the electrode tab 114 to the non-coated portion 112a, a step S840 of forming an insulating layer 115 on a portion of the electrode tab 114. Referring to FIG. 11, the sum of the thickness T2 of the electrode tab 114 and the thickness T3 of the insulating layer 115 may be less than or equal to the thickness T1 of the active material layer 113. Thus, the step S840 of forming the insulating layer may include adjusting the thickness T3 of the insulating layer 115 so that the sum of the thickness T2 of the electrode tab 114 and the thickness T3 of the insulating layer 115 does not exceed (i.e., is less than or equal to) the thickness T1 of the active material layer 113.

The step S810 of forming the metal layers 112 on both surfaces of the polymer layer 111 may be implemented in various ways—for example, by coating a metal material on both surfaces of the polymer layer 111 made of a polymer material, by forming the metal layers 112 through a physical vapor deposition (PVD) or chemical vapor deposition (CVD) method, or by attaching a thin metal film to form the metal layers 112.

The step S820 of manufacturing the electrode plate may include forming the active material layer 113 by coating an active material on a portion of the metal layers 112. The portion of the metal layers 112 where the active material layer 113 is not formed may be the non-coated portion 112a.

The step S830 of coupling the electrode tab may include placing the electrode tab 114 made of a metal on the non-coated portion 112a and integrally joining the electrode tab 114 to the non-coated portion 112a by welding, thermal fusion, or the like. In some embodiments, the electrode tab 114 may be joined to the non-coated portion 112a by ultrasonic welding. However, the method by which the electrode tab 114 is coupled to the non-coated portion 112a is not limited thereto and may vary depending on the material that forms the electrode tab 114 and/or the metal layers 112, such as laser welding, resistance welding, or heat fusion.

Referring to FIG. 9, an electrode plate 110a and the electrode tab 114, overlapped with each other and placed on an anvil 42, may be ultrasonically welded by a welding horn 41. The welding horn 41 may apply an ultrasonic vibration to the electrode plate 110a and the electrode tab 114 on the anvil 42 in a pressed state.

In some embodiments, the welding horn 41 may have a shape such as a disk, a circle, or a polygon. The welding horn 41, in a state of pressing the electrode plate 110a and the electrode tab 114, may rotate in place while pressing the overlapped surfaces of the electrode plate 110a and the electrode tab 114 continuously for bonding.

The welding horn 41 may include a body portion 41a and a welding head 41b connected to the body portion 41a. The welding head 41b may be configured in a disk shape, and a pressing surface 41c may be formed along the outer circumferential surface of the disk. The welding head 41b may rotate in a direction corresponding to the traveling direction of the electrode plate 110a and may continuously press the electrode plate 110a and the electrode tab 114 on the anvil 42. The electrode plate 110a and the electrode tab 114 may be pressed by a plurality of protrusions formed on the pressing surface 41c of the welding head 41b.

The body portion 41a may be connected to the central axis of the welding head 41b so that the welding head 41b can rotate. The body portion 41a may vibrate ultrasonically in a direction perpendicular to the traveling direction of the electrode plate 110a. As the body portion 41a vibrates, a vibration thereof is transmitted to the welding head 41b connected to the body portion 41a, and the vibration is conveyed to the electrode plate 110a and the electrode tab 114. The electrode plate 110a and the electrode tab 114 may be heated at their contact surfaces by ultrasonic vibration energy of the vibration and, thus, may be weld joined.

The anvil 42 may be configured to support the electrode plate 110a and the electrode tab 114 at a location facing the welding horn 41.

The step S830 of coupling the electrode tab may include welding and/or thermally fusing the electrode tab 114 to the non-coated portion 112a to form a joint 114a. For example, the step of welding the electrode tab 114 may include joining the electrode tab 114 to the non-coated portion 112a by ultrasonic welding using the above-described welding apparatus.

The step S830 of coupling the electrode tab may include performing welding or thermal fusion at a location spaced apart from the active material layer 113 by a predetermined distance so as to prevent the active material layer 113 from being damaged or deformed, when the electrode tab 114 is welded or thermally fused to the non-coated portion 112a. The joint 114a may be formed at a location spaced apart by the predetermined distance from the active material layer 113. In some embodiments, the step S830 of coupling the electrode tab may include welding or thermally fusing the electrode tab 114 to the non-coated portion 112a so that the joint 114a is spaced by about 0 mm to about 0.25 mm from the active material layer 113.

The step S830 of coupling the electrode tab may include welding or thermally fusing the electrode tab 114 to the non-coated portion 112a so that the width of the joint 114 a is greater than or equal to about 1 mm, and preferably greater than or equal to about 1.5 mm. In some embodiments, the joint 114 a may be set to have a minimum width sufficient to secure welding strength.

The step S830 of coupling the electrode tab may include coupling the electrode tab 114 so that it is spaced apart from the active material layer 113 by a predetermined distance. The electrode tab 114 may be arranged such that the distance it is spaced from the active material layer 113 is the same as the spacing of the joint 114a from the active material layer 113. The joint 114a may be formed at the end of the electrode tab 114. In some embodiments, the step S830 of coupling the electrode tab may include welding or thermally fusing the electrode tab 114 to the non-coated portion 112a so that the electrode tab 114 is spaced by about 0 mm to about 0.25 mm from the active material layer 113.

The step S840 of forming the insulating layer may include forming the insulating layer 115 on the joint 114a of the electrode tab 114 joined to the non-coated portion 112a by welding or thermal fusion. The step S840 of forming the insulating layer may include forming the insulating layer 115 so that the width of the insulating layer 115 is greater than or equal to the width of the joint 114a.

The step S840 of forming the insulating layer may include coating an insulating solution on a portion of the electrode tab 114. The step of coating the insulating solution may include spraying the insulating solution on a portion of the electrode tab 114 and a step of drying the sprayed insulating solution. The step of spraying the insulating solution on a portion of the electrode tab 114 may include adjusting the spraying speed of the insulating solution in consideration of at least one of surface uniformity or thickness of the insulating layer 115. To ensure that the insulating solution is evenly applied to the electrode tab 114, it may be sprayed so that the surface roughness Ra of the coated insulating solution is less than or equal to a predetermined value. Also, the spraying speed of the insulating solution may be adjusted so that the sum of the thickness T3 of the insulating layer 115 coated on a portion of the electrode tab 114 and the thickness T2 of the electrode tab 114 does not exceed (i.e., is less than or equal to) the thickness T1 of the active material layer 113. Further, after the insulating solution is sprayed so that the sum of the thickness T3 of the insulating solution coated on a portion of the electrode tab 114 and the thickness T2 of the electrode tab 114 exceeds the thickness T1 of the active material layer 113, a pressing process may be performed so that, in the final state, the sum of the thickness T3 of the coated insulating solution and the thickness T2 of the electrode tab 114 is less than or equal to the thickness T1 of the active material layer 113.

The step S840 of forming the insulating layer may include attaching an insulating tape to a portion of the electrode tab 114. The step S840 of forming the insulating layer may include attaching the insulating tape in consideration of the thicknesses of the active material layer 113 and/or the electrode tab 114. Further, the insulating tape may be attached to a portion of the electrode tab using a UV-curable adhesive. The surface of the electrode tab 114 may be pretreated by chemical treatment or physical surface polishing to improve adhesion. After a UV-curable adhesive is applied to the pretreated surface of the electrode tab 114, the insulating tape may be attached thereon. Subsequently, UV light may be irradiated for a predetermined time using a UV curing device to cure the adhesive, thereby fixing the insulating tape to a portion of the electrode tab 114. However, the method of attaching the insulating tape to a portion of the electrode tab 114 is not limited thereto, and heat bonding, pressing, and other methods may be used.

The step S840 of forming the insulating layer may include forming the insulating layer 115 on the electrode tab 114 so that the insulating layer 115 is spaced by about 0 mm to about 0.25 mm from the active material layer 113. If the electrode tab 114 is welded to the non-coated portion 112 a so as to be spaced by about 0 mm to about 0.25 mm from the active material layer 113, the insulating layer 115 may also be formed at the same spacing from the active material.

In some embodiments, the step S840 of forming the insulating layer may include forming the insulating layer 115 to extend from the joint 114a onto the non-coated portion 112a exposed between the electrode tab 114 and the active material layer 113. When the electrode tab 114 is arranged to be spaced apart from the active material layer 113 by a predetermined distance, a portion of the non-coated portion 112a may be exposed through the gap between the electrode tab 114 and the active material layer 113. Thus, the insulating layer 115 may be arranged to cover the joint 114a and the non-coated portion 112a exposed between the electrode tab 114 and the active material layer 113.

Although the present disclosure has been described with reference to embodiments and drawings illustrating aspects thereof, the present disclosure is not limited thereto. Various modifications and variations can be made by a person skilled in the art to which the present disclosure belongs.

### DESCRIPTION OF SOME REFERENCE SYMBOLS

100: electrode assembly 110: electrode, first electrode
111: polymer layer 112: metal layer
113: active material layer 114: electrode tab
115: insulating layer 116: first electrode tab
126: second electrode tab 200: case
210: case body 220: cap assembly
300: secondary battery

What is claimed is:

1. An electrode comprising:
a polymer layer including an insulating material;
a metal layer formed on two sides of the polymer layer;
an active material layer formed on a portion of the metal layer so that the metal layer includes a coated portion including the active material layer and a non-coated portion where the active material layer is not provided;
an electrode tab coupled to at least part of the non-coated portion; and
an insulating layer formed on a portion of the electrode tab,
wherein a sum of a thicknesses of the electrode tab and a thickness of the insulating layer is less than or equal to a thickness of the active material layer.

2. The electrode as claimed in claim 1, wherein the electrode tab is joined to the non-coated portion by welding or by thermal fusion, and wherein the electrode tab includes a joint formed by the welding or by the thermal fusion.

3. The electrode as claimed in claim 2, wherein the insulating layer is formed on:
the joint of the electrode tab;
a partial region of the electrode tab that includes the joint of the electrode tab; or
the joint of the electrode tab and a portion of the active material layer.

4. The electrode as claimed in claim 3, wherein a width of the insulating layer is identical to a width of the joint or is greater than the width of the joint.

5. The electrode as claimed in claim 1, wherein the insulating layer includes an insulating-solution-coating portion that is coated by an insulating solution.

6. The electrode as claimed in claim 5, wherein the insulating solution includes at least one of polyimide (PI), ceramic, silicone, Ethylene Tetrafluoroethylene (ETFE), and Polychlorotrifluoroethylene (PCTFE).

7. The electrode as claimed in claim 1, wherein the insulating layer includes an insulating tape.

8. The electrode as claimed in claim 7, wherein the insulating tape includes at least one of acrylic, rubber, polyimide (PI), ethylene tetrafluoroethylene (ETFE), ceramic, silicone, polyester (PET), and polychlorotrifluoroethylene (PCTFE).

9. A secondary battery comprising:
an electrode assembly including a first electrode, a separator, and a second electrode; and
a case housing the electrode assembly,
wherein at least one of the first electrode and the second electrode includes:
a polymer layer including an insulating material;
a metal layer formed on two sides of the polymer layer;
an active material layer formed on a portion of the metal layer so that the metal layer includes a coated portion including the active material layer and a non-coated portion where the active material layer is not provided;
an electrode tab coupled to at least part of the non-coated portion; and
an insulating layer formed on a portion of the electrode tab, and
wherein a sum of a thicknesses of the electrode tab and a thickness of the insulating layer is less than or equal to a thickness of the active material layer.

10. The secondary battery as claimed in claim 9, wherein the electrode tab is joined to the non-coated portion by welding or by thermal fusion, and wherein the electrode tab includes a joint formed by the welding or by the thermal fusion.

11. The secondary battery as claimed in claim 10, wherein the insulating layer is formed on:
the joint of the electrode tab;
a partial region of the electrode tab that includes the joint of the electrode tab; or
the joint of the electrode tab and a portion of the active material layer.

12. A method of manufacturing an electrode, the method comprising:
forming a metal layer on each of two surfaces of a polymer layer including an insulating material;
forming an active material layer on a portion of the metal layer so that the metal layer includes a coated portion including the active material layer and a non-coated portion where the active material layer is not provided;
coupling an electrode tab including a metal to the non-coated portion;
after coupling the electrode tab to the non-coated portion, forming an insulating layer on a portion of the electrode tab, and
wherein a sum of a thickness of the electrode tab and a thickness of the insulating layer is less than or equal to a thickness of the active material layer.

13. The method as claimed in claim 12, wherein coupling the electrode tab includes welding or thermally fusing the electrode tab to the non-coated portion so that a joint is formed in the electrode tab.

14. The method as claimed in claim 13, wherein forming the insulating layer includes:
forming the insulating layer on the joint of the electrode tab;
forming the insulating layer on a partial region of the electrode tab that includes the joint of the electrode tab; or
forming the insulating layer on the joint of the electrode tab and a portion of the active material layer.

15. The method as claimed in claim 13, further comprising forming the insulating layer so that a width of the insulating layer is about greater than or equal to a width of the joint.

16. The method as claimed in claim 12, wherein forming the insulating layer includes coating an insulating solution on a portion of the electrode tab.

17. The method as claimed in claim 16, wherein coating the insulating solution on a portion of the electrode tab includes spraying the insulating solution onto the portion of the electrode tab.

18. The method as claimed in claim 17, wherein coating the insulating solution on a portion of the electrode tab further includes drying the insulating solution after the insulating solution is sprayed onto the portion of the electrode tab.

19. The method as claimed in claim 12, wherein forming the insulating layer includes attaching an insulating tape to a portion of the electrode tab.

20. The method as claimed in claim 19, wherein attaching the insulating tape to the portion of the electrode tab includes attaching, to a portion of the electrode tab, an insulating tape having at least one of acrylic, rubber, polyimide (PI), ethylene tetrafluoroethylene (ETFE), ceramic, silicone, polyester (PET), and polychlorotrifluoroethylene (PCTFE).
